(19) United States
(12) Patent Application Publication
(10) Pub. No.: US 2025/0384627 A1
(43) Pub. Date: Dec. 18, 2025

(54) SYSTEM AND METHOD FOR REAL-TIME THREE-DIMENSIONAL RECONSTRUCTION AND STREAMING OF SPORTS EVENTS AND CONCERTS

(71) Applicant: Carnegie Mellon University, Pittsburgh, PA (US)

(72) Inventors: Fernando De La Torre Frade, Pittsburgh, PA (US); Francisco Vicente Carrasco, Pittsburgh, PA (US); Albert Mosella Montoro, Terrasa (ES); Alejandro Amat Payá, Pittsburgh, PA (US); Saswat Subhajyoti Mallick, Pittsburgh, PA (US); Bernhard Kerbl, Graz (AU); Junkai Huang, San Jose, CA (US); Marc Ruiz Olle, Pittsburgh, PA (US)

(73) Assignee: Carnegie Mellon University, Pittsburgh, PA (US)

(21) Appl. No.: 19/239,515

(22) Filed: Jun. 16, 2025

Related U.S. Application Data
(60) Provisional application No. 63/660,189, filed on Jun. 14, 2024.

(51) Int. Cl. G06T 17/10; G06T 7/11

(52) U.S. Cl. CPC G06T 17/10; G06T 7/11

(57) ABSTRACT

The invention comprises embodiments of a system and method for real-time, three-dimensional reconstruction of dynamic, human-centered scenes from multi-view video streams, leveraging a two-level parallel computation strategy to efficiently reconstruct multiple frames and multiple dynamic elements simultaneously.

### CROSS-REFERENCE TO RELATED APPLICATION

This application claims priority to U.S. Provisional Application Ser. No. 63/660,189, filed on Jun. 14, 2024, which application is incorporated by reference herein in its entirety.

### FIELD OF THE INVENTION

The invention resides in the intersecting domains of three-dimensional (“3D”) image processing, computer vision, computer graphics, real-time distributed computing, and interactive multimedia transmission.

### BACKGROUND OF THE INVENTION

Two-dimensional (“2D”) television broadcasts remain the dominant medium for live sports. While production crews can deploy dozens of cameras and real-time cutting systems, viewers are confined to the producer's chosen angle, with no ability to move through the scene.

Early multi-view replay systems attempted to address this constraint. EyeVision® 360, debuting during Super Bowl 2001, ringed the stadium with multi-view robotic high-definition (“HD”) cameras and interpolated frames to create a “bullet-time” effect, but it required fixed infrastructure, offline processing, and offered only canned replays rather than continuous real-time navigation. Intel's freeD/TrueView platform later installed 36-38 industrial cameras in NFL venues and processed roughly a terabyte of voxel data per 15-30 s clip, delivering striking 360° replays yet still dependent on massive server racks and manual curation, not real-time exploration. Commercial “auto-production” services such as Spiideo's® Multi-Angle Autocasting replace human operators with artificial intelligence (“AI”)-driven camera switching, but the output remains conventional 2D streams without six-degree-of-freedom (“6-DoF”) for the viewer.

Volumetric video research introduced genuine 6-DoF playback. U.S. Pat. No. 10,469,820 describes server-side rendering and viewport-dependent streaming of compressed geometry and video textures, reducing client load but presupposing a pre-captured, pre-meshed volume and suffering from server latency. Academic surveys confirm that bandwidth, compression efficiency, and view-adaptive rate control still limit widespread deployment of volumetric streaming.

Neural radiance fields (“NeRF”) marked a step-change in visual quality for novel-view synthesis, yet standard NeRF requires thousands of ray-sample evaluations per frame; even accelerated variants still prohibit real-time rendering on commodity graphic processing units (“GPUs”). Recent surveys list real-time inference, large memory footprints, and lengthy per-scene optimization as persistent obstacles. Mobile measurements corroborate these bottlenecks, showing that current NeRF pipelines exceed the compute and power budgets of untethered head-mounted displays.

Point-based rasterization methods, notably 3D Gaussian Splatting (“3DGS”), achieve millisecond-level rendering while preserving photorealism. However, extending 3DGS from static to dynamic scenes is non-trivial: fully four-dimensional Gaussian splats allocate redundant parameters to static background regions, inflating memory and computation-a limitation explicitly identified by hybrid 3D-4DGS work that still reports substantial overhead. Deformable and fully explicit dynamic 3DGS pipelines likewise note that, without explicit motion priors, optimization can stall and quality degrades when objects move abruptly, impeding real-time deployment.

Existing multi-camera replays lack viewer-controlled navigation, volumetric streaming solutions depend on heavy pre-processing and server bandwidth, NeRF-based approaches remain too slow for live use, and current dynamic 3DGS methods either over-consume resources or succumb to motion-induced artefacts. A gap therefore persists for an end-to-end system that acquires, reconstructs, compresses, transmits, and renders live sports scenes as interactive, photorealistic 3D experiences within the strict latency and scalability constraints of global broadcasting infrastructures.

### BRIEF SUMMARY OF THE INVENTION

One embodiment of the present invention relates to a computer system and method for real-time, three-dimensional reconstruction of dynamic, human-centered scenes from multi-view video streams, leveraging a two-level parallel computation strategy to efficiently reconstruct multiple frames and multiple dynamic elements simultaneously. The system incorporates distributed processing nodes, optimized to handle parallel execution tasks.

Parallelization occurs first at the frame-level, where consecutive multi-view frames are processed simultaneously across distributed GPUs, which are then broadcasted together. A second parallelization occurs at the element-level, wherein each dynamic element within the scene, such as individual humans or selected objects, undergoes independent reconstruction simultaneously, finally coalescing into an aggregated representation, followed by a refinement stage to form a per-frame pointcloud.

Various embodiments of the invention differentiate between dynamic elements (such as people or moving objects) and non-dynamic elements (static background), processing each through tailored reconstruction methods using a splatting-based method.

For dynamic elements classified as human subjects, the system initializes 3D primitives from either a fitted parametric human model or via a dual-branch renderer comprising a direct primitive optimization branch and a parametric predictive branch. After initial setup, dynamic primitives undergo refinement processes, including pose estimation, skeleton optimization via photometric loss minimization, and appearance adjustments.

One embodiment of the present invention is a computer-implemented method using at least one processing unit with memory for creating a three-dimensional reconstruction of a dynamic scene from a plurality of 2D video streams, each 2D stream comprised of plurality of consecutive frames and each frame at a time “t”. This method embodiment comprises the following steps for each time “t”. First, identifying at least one element in an environment a frame at a time. Second, segmenting the frame to obtain at least one per-element segmentation mask and categorizing the element as dynamic or static. Third, optimizing, using one of a plurality of parallel processor units, by employing an optimization method for dynamic elements or an optimization method for static elements to create an optimized and refined model for the dynamic elements and the static elements. Fourth, aggregating, from each parallel processing unit, the optimized and refined models for all elements into a unified three-dimensional model for the time t. Fifth, refining by detecting an area where a predetermined error level is exceeded and adding at least one three-dimensional primitive to reduce the error. Sixth, rendering a unified three-dimensional model for the time t.

Another embodiment of a method according to the invention employes an optimizing method for a dynamic element that is a human, with the method comprising the steps of: (1) gathering a plurality of multi-view frames showing the human at time t; (2) generating an estimated three-dimensional pose model of the human; (3) generating a detailed splatting-based reconstruction of the human using three-dimensional primitives on a reference T-pose model; (4) fitting a parametric human mesh model having mesh vertices to the T-pose model to obtain a three-dimensional skeleton and at least one skinning weights; (5) assigning each of the three-dimensional primitives from the T-pose model to a nearest mesh vertex on the three-dimensional human mesh model and each of the three-dimensional primitive inherits a skinning weight; (6) extracting, for each frame at time t, at least one 2D landmark and triangulating to compute a corresponding three-dimensional posed skeleton; and (7) refining the three-dimensional posed skeleton by optimizing at least one parameter of the primitives to create the optimized and refined model.

Another embodiment of a method according to the invention employs an optimizing method in which the at least one parameter is selected from the group consisting of position, scale, rotation, opacity, and spherical harmonic coefficients.

Another embodiment of the present invention comprises the optimizing method for the static element that is an environment having a foreground and a background, with the method comprising: (1) fitting a three-dimensional primitives model of an empty version of the environment using a plurality of training views to capture a geometry of the environment, wherein the three-dimensional primitives have geometric parameters; (2) optionally, increasing a density of the model of the environment in a region of interest; and (3) freezing the geometric parameters of the three-dimensional primitives.

Another embodiment of a method of the present invention comprises performing the following per-frame processing steps for the environment at time t, optimizing, for spherical harmonics only for a subsequent frame at time t+1, by focusing exclusively on one or more appearance parameters of three-dimensional primitives in the background. This method can be further modified, in alternative embodiments, further comprising any of the following performance enhancements: (1) caching any changes to the three-dimensional primitives in the background to avoid recomputation for each iteration; (2) capturing any operations of the processor for rendering and spherical harmonics optimization of static three-dimensional primitives as a static computational graph; and (3) redistributing Gaussians to balance an uneven Gaussian counts per pixel count.

Another embodiment of the invention is a non-transitory computer-readable storage medium storing one or more programs for creating a three-dimensional reconstruction of a dynamic scene from a plurality of 2D video streams, each 2D stream comprised of plurality of consecutive frames and each frame at a time “t”, the one or more programs comprising instructions, which when executed by at least one processor of an electronic system, cause the electronic system to perform the following steps for each time “t”: (1) identifying at least one element in an environment a frame at a time; (2) segmenting, using a processing unit, the frame to obtain at least one per-element segmentation mask and categorizing the element as dynamic or static; (3) optimizing, using one of a plurality of parallel processor units, by employing an optimization method for dynamic elements or an optimization method for static elements to create an optimized and refined model for the dynamic elements and the static elements; (4) aggregating, from each parallel processing unit, the optimized and refined models for all elements into a unified three-dimensional model for the time t; and (5) refining by detecting an area where a predetermined error level is exceeded and adding at least one three-dimensional primitive to reduce the error; and (6) rendering a unified three-dimensional model for the time t.

Another embodiment of the optimizing method of the non-transitory computer-readable storage medium of the present invention, as applied to a dynamic element that is a human, comprises: (1) gathering a plurality of multi-view frames showing the human at time t; (2) generating an estimated three-dimensional pose model of the human; (3) generating a detailed splatting-based reconstruction of the human using three-dimensional primitives and a reference T-pose model; (4) fitting a parametric human mesh model having mesh vertices to the T-pose model to obtain a three-dimensional posed skeleton and at least one skinning weight; (5) assigning each of the three-dimensional primitives from the T-pose model a nearest mesh vertex on the three-dimensional human mesh model and each of the three-dimensional primitive inherits its skinning weights; (6) extracting, for each frame at time t, at least one 2D landmarks and triangulating to compute the corresponding three-dimensional posed skeleton; and (7) refining the three-dimensional posed skeleton by optimizing at least one of the parameters of the primitives to create the optimized and refined model.

Another embodiment of the non-transitory computer-readable storage medium of the present invention includes, at the refining step, optimizing at least one parameter of the transformed three-dimensional primitives selected from the group consisting of position, scale, rotation, opacity, and spherical harmonic coefficients. In another embodiment, the optimizing method for the static element that is an environment having a foreground and a background comprises: (1) fitting a three-dimensional primitives model of an empty version of the environment using a plurality of training views to capture a geometry of the environment, wherein the three-dimensional primitives have geometric parameters; (2) optionally, increasing a density of the model of the environment in a region of interest; and (3) freezing the geometric parameters of the three-dimensional primitives. This embodiment can be further refined by incorporating the following per-frame processing step for the environment at time t: optimizing, for spherical harmonics only for a subsequent frame at time t+1, by focusing exclusively on one or more appearance parameters of three-dimensional primitives in the background.

Another embodiment of the present invention further comprises incorporating any of the following performance enhancements into one of the previously-described embodiments of a non-transitory computer-readable storage medium described herein: (1) caching any changes to the three-dimensional primitives in the background to avoid recomputation for each iteration; (2) capturing any operations of the processing unit for rendering and spherical harmonics optimization of static three-dimensional primitives as a static computational graph; and (3) redistributing Gaussians to balance an uneven Gaussian counts per pixel count.

A further embodiment of the present invention is a computer system for real-time three-dimensional reconstruction of a dynamic scene from a plurality of multi-view video streams, the system comprising a video acquisition system configured to run on at least one processor with at least one memory configured to receive and store a plurality of multi-view video streams of a human-centered dynamic scene, wherein each video stream is comprised of a plurality of consecutive frames and each frame is at a time t and a plurality of processing nodes, each node comprising at least one processing unit configured for parallel computation of the frames, wherein the memory, processing nodes, and processing units are configured to generate a three-dimensional representation of the dynamic scene by performing the following steps comprising the following steps for each time “t”: (1) identifying at least one element in an environment a frame at a time; (2) segmenting, using a processing unit, the frame to obtain at least one per-element segmentation mask and categorizing the element as dynamic or static; (3) optimizing, using one of a plurality of parallel processor units, by employing an optimization method for dynamic elements or an optimization method for static elements to create an optimized and refined model for the dynamic element and the static elements; (4) aggregating, from each parallel processing unit, the optimized and refined models for all elements into a unified three-dimensional model for the time t; (5) refining by detecting an area where a predetermined error level is exceeded and adding at least one three-dimensional primitive to reduce the error; and (6) rendering a unified three-dimensional model for the time t.

### BRIEF DESCRIPTION OF THE SEVERAL VIEWS OF THE DRAWINGS

For the purpose of facilitating understanding of the invention, the accompanying drawings and description illustrate embodiments thereof, from which the invention, various embodiments of its structures, construction, and methods of operation, and many advantages, may be understood and appreciated. The accompanying drawings are hereby incorporated by reference.

FIG. 1 illustrates an overall flowchart for one embodiment of a system and method of the presenting invention including: (a) a set of multi-view cameras, (b) a set of multi-view video streams, (c) a 3D reconstruction system, and (d) a novel-view video stream;

FIG. 2 is flowchart of one embodiment of a system and method to create a real-time rendering of a life event according to the present invention;

FIG. 3 is charts of the optimization routines of one system and method of the present invention;

FIGS. 4A and 4B illustrates one embodiment of a dynamic (human) optimization pipeline;

FIG. 5 is a representation of one embodiment of a static optimization pipeline; and

FIG. 6 shows one embodiment of a system of the present invention with various hardware components.

### DETAILED DESCRIPTION OF THE INVENTION

The following describes example embodiments in which the present invention may be practiced. This invention, however, may be embodied in many different ways, and the descriptions provided herein should not be construed as limiting in any way. Among other things, the following invention may be embodied as methods, systems, or devices. The following detailed descriptions should not be taken in a limiting sense. The accompanying drawings are hereby incorporated by reference.

Before the example embodiments of the devices and methods according to the present disclosure are disclosed and described below, it is to be understood that embodiments are not limited to those described within this disclosure. Numerous modifications and variations therein will be apparent to those skilled in the art and remain within the scope of the disclosure. It also is to be understood that the terminology used herein is for the purpose of describing specific embodiments only and is not intended to be limiting. Some embodiments of the disclosed technology will be described more fully hereinafter with reference to the accompanying drawings. This disclosed technology, however, may be embodied in many different forms and should not be construed as limited to the embodiments set forth therein.

If the specification states a component, element, part, or feature “may,” “can,” “could,” or “might” be included or have a characteristic, then that particular component or feature is not required to be included or have the characteristic.

In the following description, numerous specific details are set forth. However, it is to be understood that embodiments of the disclosed technology may be practiced without these specific details. In other instances, well-known methods, structures, and techniques have not been shown in detail in order not to obscure an understanding of this description. References to “one embodiment,” “an embodiment,” “example embodiment,” “some embodiments,” “certain embodiments,” “various embodiments,” etc., indicate that the embodiment(s) of the disclosed technology so described may include a particular feature, structure, or characteristic, but not every embodiment necessarily includes that particular feature, structure, or characteristic. Further, repeated use of the phrase “in one embodiment” does not necessarily refer to the same embodiment, although it may.

Unless otherwise noted, the terms used herein are to be understood according to conventional usage by those of ordinary skill in the relevant art. In addition to any definitions of terms provided below, it is to be understood that as used in the specification and in the claims, the terms “a” or “an” are used, as is common in patent documents, to include one or more than one. In this document, the term “or” is used to refer to a nonexclusive “or” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The terms “connected”, “interconnected”, “in communication”, or “coupled” and related terms are used in an operational sense and are not necessarily limited to a direct physical connection or coupling. As an example, two or more devices, databases, websites, or platforms may be coupled directly, or via one or more intermediary channels or devices. They may be hardwired to each other or connected without hardwiring, such as by wi-fi, Bluetooth®, or cellular service. As another example, devices, databases, websites, or platforms may be coupled in such a way that information can be passed between them, while sharing or not sharing any physical connection with one another. Based on the disclosure provided herein, one of ordinary skill in the art will appreciate a variety of ways in which connection or coupling exists in accordance with the aforementioned definition.

The various embodiments of the present invention can incorporate or be configured to run on one or more computing systems, which can include one or more processor(s) or processing unit(s) 3 (e.g., central processing units (“CPUs”), graphical processing units (“GPUs”), holographic processing units (“HPUs”), etc.)

The various methods and systems of the present invention can be configured to run on a processor-based system that includes one or more central processing units 3, each including one or more processors. The CPU(s) 3 can be a master device and can have a cache memory coupled to the processor(s) for rapid access to temporarily stored data. The CPU(s) 3 can be coupled to a system bus and can intercouple master and slave devices included in a processor-based system. As known in the art, the CPU(s) 3 can communicate with other devices by exchanging address, control, and data information over the system bus. For example, the CPU 3 can communicate bus transaction requests to a memory controller as an example of a slave device. Additionally, multiple system buses can be provided, wherein each system bus constitutes a different fabric.

Computing system(s) can include one or more input devices 100 that provide input to the processors, notifying them of actions. The actions can be mediated by a hardware controller that interprets the signals received from the input device and communicates the information to the processors using a communication protocol. Each input device can include, for example, a mouse, a keyboard, a touchscreen, a touchpad, a wearable input device (e.g., a haptics glove, a bracelet, a ring, an earring, a necklace, a watch, etc.), a camera 100 (or other light-based input device, e.g., an infrared sensor), a microphone, or other user input devices.

Processors can be coupled to other hardware devices, for example, with the use of an internal or external bus, such as a PCI bus, SCSI bus, or wireless connection. The processors can communicate with a hardware controller for devices, such as for a display. Display can be used to display text, images, and graphics. In some implementations, display includes the input device as part of the display, such as when the input device is a touchscreen or is equipped with an eye direction monitoring system. In some implementations, the display is separate from the input device. Examples of display devices include the following: an LCD display screen, an LED display screen, a projected, holographic, augmented reality display or virtual reality display (such as a heads-up display device or a head-mounted device) (collectively viewing device 2), and so on. Other input/output (“I/O”) devices can also be coupled to the processor, such as a network chip or card, video chip or card, audio chip or card, USB, firewire or other external device, camera, printer, speakers, CD-ROM drive, DVD drive, disk drive, etc.

Computing system can include a communication device capable of communicating wirelessly or wire-based with other local computing devices or a network node. The communication device can communicate with another device or a server through a network using, for example, TCP/IP protocols. Computing system can utilize the communication device to distribute operations across multiple network devices.

The processors and processing units 3 can have access to a memory 4, which can be contained on one of the computing devices of computing system or can be distributed across of the multiple computing devices of computing system or other external devices. A memory 4 includes one or more hardware devices for volatile or non-volatile storage and can include both read-only and writable memory. For example, a memory can include one or more of random-access memory (“RAM”), various caches, CPU registers, read-only memory (“ROM”), and writable non-volatile memory, such as flash memory, hard drives, floppy disks, CDs, DVDs, magnetic storage devices, tape drives, and so forth. Memory 4 can include a non-transitory computer-readable storage medium storing one or more programs for generating a 3D reconstruction of a scene, the one or more programs comprising instructions, which, when executed by at least one processor of an electronic system, cause the electronic system to perform the methods and processes described herein. Memory can include or comprise a buffer 4, which is a temporary storage area in memory used to hold data while it's being transferred between different parts of a computer system or between different devices. The buffer 4 can act as an intermediary, smoothing out differences in data transfer speeds and ensuring efficient data flow (such as a stream buffer 632 for smoothing out the transmission of the 3D representation stream 140. A memory is not a propagating signal divorced from underlying hardware; a memory is thus non-transitory. Memory can include program memory that stores programs and software, such as an operating system, a local physical environment modeling application, and other application programs. Memory can also include data memory that can include eyeprint content, preconfigured templates for password generation, hand gesture patterns, configuration data, settings, user options or preferences, etc., which can be provided to the program memory or any component of the computing system.

Software may include one or more computer readable instruction that when executed by one or more component, e.g., a processor, causes the component to perform a specified function. It should be understood that the algorithms/processes/methods described herein may be stored on one or more non-transitory computer-readable medium. Exemplary non-transitory computer-readable media may include a non-volatile memory, a random access memory (“RAM”), a read only memory (“ROM”), a CD-ROM, a hard drive, a solid-state drive, a flash drive, a memory card, a DVD-ROM, a Blu-ray Disk, a laser disk, a magnetic disk, an optical drive, combinations thereof, and/or the like. Such non-transitory computer-readable media may be electrically based, optically based, magnetically based, resistive based, and/or the like.

Some implementations can be operational with numerous other computing system environments or configurations. Examples of computing systems, environments, and/or configurations that may be suitable for use with the technology include, but are not limited to, virtual reality headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

Network can be a local area network (“LAN”), a wide area network (“WAN”), a mesh network, a hybrid network, or other wired or wireless networks. Network may be the Internet or some other public or private network. Computing devices can be connected to network through a network interface, such as by wired or wireless communication. While the connections between parts, components, modules, and servers are shown as separate connections, these connections can be any kind of local, wide area, wired, or wireless network, including network or a separate public or private network.

In some implementations, an analysis engine executed by the virtual reality device or a remote system that is receiving images from the virtual reality device can automatically identify features of interest in the primary user's environment and can identify them for the primary and/or second user. For example, the analysis engine can include machine learning models trained to identify damage to particular types of objects, where the models can be trained using pictures from previously verified insurance claims. As another example, the analysis engine can automatically compare images previously submitted by the primary user (e.g., pictures of particular objects) to new images to identify differences (e.g., that may indicate damage). The indications from the analysis engine can include directions to the primary user to focus on the identified locations in the primary user's local environment or indications to the second user, for the second user to provide the instructions to the primary user.

Other master and slave devices can be connected to the system bus. These devices can include a memory system, one or more input devices, one or more output devices, one or more network interface devices, and one or more display controllers, as non-limiting examples. The input device(s) can include any time of device, including but not limited to input keys, switches, voice processors, etc. The output device(s) can include any type of output device including, but not limited to, audio, video, other visual indicators, etc. The network interface device(s) can be configured to support any type of communications protocol desired. The memory or memory system can include one or more memory unites.

The CPU(s) 3 can be configured to access the display controller(s) over the system bus to control information sent to one or more displays. The display controller(s) sends information to the display(s) to be displayed via one or more video processors, which process the information to be displayed into a format suitable for he display(s). The display(s) can include any type of display, including, but not limited to, a cathode ray tube, a liquid crystal display, a plasma display, and/or a light emitting diode display.

The processor-based system(s) can be provided in an integrated circuit. The memory system may include a memory array(s) and/or memory bit cells. The processor-based system can be provided in a system-on-a-chip.

Those of skill in the art will further appreciate the various illustrative logical blocks, modules, circuits, and algorithms described in connection with the aspects disclosed herein may be implemented as electronic hardware, instructions stored in memory or in another computer readable medium and executed by a processor or other processing device, or a combination of both. The master devices and slave devices described herein may be employed in any circuit, hardware component, integrated circuit, or integrated circuit chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure. “Component” and “module” are used herein to refer to the hardware and the software, respectively, to achieve a goal and are used interchangeably herein. It will be obvious to one stilled in the art that, a “module” represents all or a part of a process or method defined by its goal our output and includes the software, code, programs, etc. to achieve that goal or output. A “component” generally includes all necessary hardware configured to run or execute a “module”. Any process can be represented by the component or module involved in executing that process.

The various illustrative logical blocks, components, modules, and circuits described in connection with the aspects disclosed herein may be implemented or performed with a processor, a digital signal processor, an application specific integrated circuit, a field programmable gate array, or other programmable logic device, discrete gate or transistor logic, discrete hardware components, or any combination thereof designed to perform the functions described herein. A processor may be a microprocessor, any conventional processor, controller, microcontroller, or state machine. A processor can be implemented as a combination of computing devices.

The aspects disclosed herein can be embodied in hardware and in instructions that are stored in hardware, and can reside, for example in random access memory, flash memory, read only memory, electrically programmable ROM, electrically erasable programmable ROM, registers, a hard disk, a removable disk, a CD-ROM, or any other form of computer readable medium. In the alternative, the storage medium can be integral to the processor. The processor and the storage medium can reside in an application-specific integrated circuit (“ASIC”). The ASIC can reside in a remote station. Alternatively, the processor and the storage medium can reside as discrete components in a remote station, base station, or server.

Those of skill in the art will understand that information and signals can be represented using any of a variety of different technologies and techniques. For example, data, instructions, commands, information, signals, bits, symbols, and chips that are referenced throughout this description can be represented by voltage, currents, electromagnetic waves, magnetic fields or particles, optical fields or particles, or any combination thereof.

Various systems and methods (also referred to as “process(es)”) of the present invention accept as input images or videos. It will be obvious to one skilled in the art that images and videos can be captured by a wide variety of devices 100 including but not limited to digital imaging devices such as include digital cameras 100, camera modules 100, camera phones 100, tablet cameras 100, etc. As technology develops, others types of image or video capture devices 100 may be developed that can be used with the systems and methods of the present invention. Similarly, the recreated event can be viewed on a number of existing and yet-to-be-created viewing devices 2 including but not limited to televisions, computers, laptops, smart phones, tablets, virtual reality headsets, virtual reality glasses, a wide variety of other augmented and virtual reality (“AR/VR”), and other immersive media applications. The cameras 100 are capable of capturing red, green, blue (“RGB”) images or (or red, green, blue, depth (“RGB-D”) images.

Various systems, non-transitory storage media-based systems, and methods 1000 (also referred to as “process(es)”) of the present invention accept as input a set of RGB images capturing the subject's appearance and are further compatible with RGB-D data comprising both color and depth information. The present invention relates to systems and methods 1000 for real-time generation of dynamic, human-centered scenes 110. The scenes 110 are captured as video streams. The systems 2000 and methods 1000 accept as input a set of RGB images capturing at least one subject's appearance and are further compatible with RGB-D data comprising both color and depth information.

Within the field of photography, an “image” is a single visual representation captured by a camera 100, while a frame is a single, still image within a sequence of images, like in a video. For example, a photograph is a single image, whereas a video is composed of many frames displayed rapidly to create the illusion of motion. The systems 2000 and methods 1000 of the present invention process input data that is comprised of RGB or RGB-D images or frames and, optionally, depth information, calibration information, and/or other information gathered or provided by an imaging device.

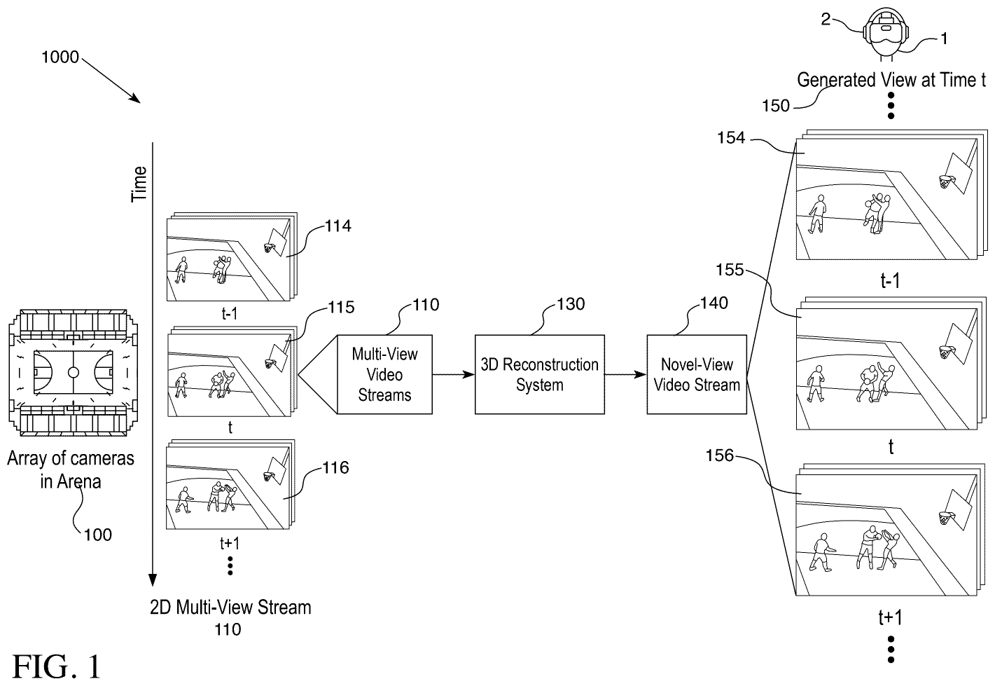

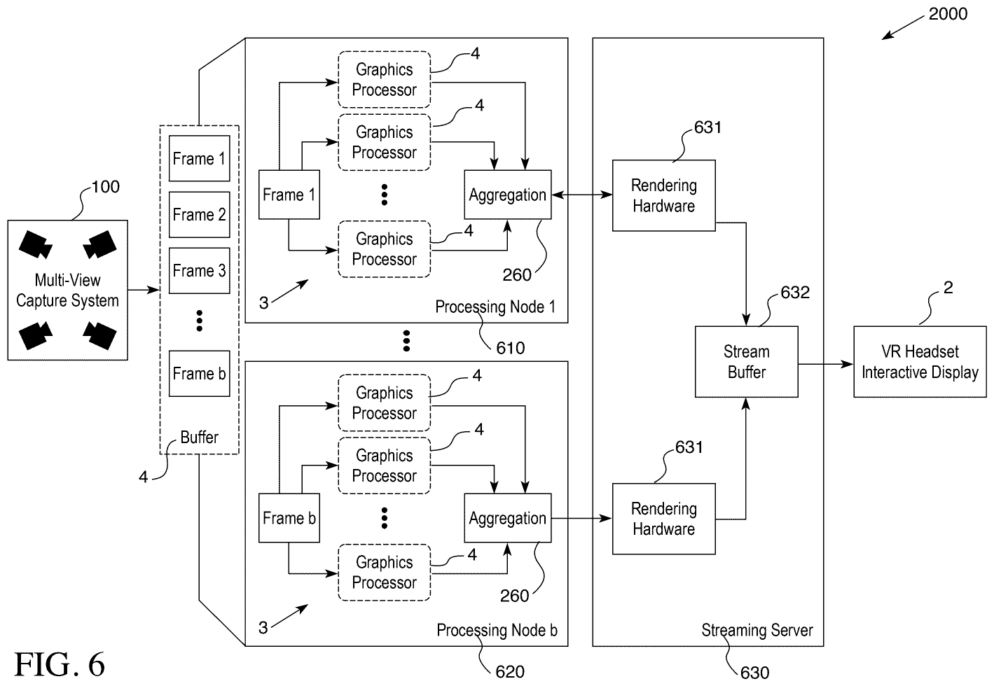

Embodiments of the present invention reside in the intersecting domains of three-dimensional image processing, computer vision, computer graphics, real-time distributed computing, and interactive multimedia transmission. They pertain to processes, methods 1000, systems 2000, and software architectures for (i) acquiring synchronized multi-view video of a live event 110 (for the purpose of explaining the invention herein, sports events or human-centric events (e.g., concerts) are used as non-limiting examples), (ii) reconstructing 130 video streams 110 of the events on-the-fly into photo-realistic, six-degree-of-freedom volumetric scenes 140 via 3D (Gaussian) Splatting, and (iii) encoding, streaming, and rendering the resulting dynamic 3D content at interactive frame rates to client devices, which are usually remote. Various embodiments of the invention, therefore, target end-to-end, low-latency 3D live streaming and free-viewpoint playback of human-centric activities, enabling immersive remote attendance or viewing that can surpass traditional 2D broadcasts. See FIGS. 1 and 6 for illustrations of various embodiments of the overall systems 2000 and methods 1000 of the present invention, and their component parts.

Various embodiments of the present invention are discussed herein as employing 3D Gaussian Splatting. Three-dimensional Gaussian Splatting is one example of incorporating 3D primitives into the various methods and systems disclosed herein. There are other, similar technologies/processes that can be incorporated instead of or in addition to 3D Gaussian Splatting including, but not limited to, Beta splatting, 3D Convex Splatting, Tetrahedron Splatting, and Triangle Splatting. All these methods, and other analogous methods, are referred to collectively herein as “3D primitives”. References herein to “Gaussian” splatting are not limited to that specific technology, but include other analogous technologies.

Additionally, the various embodiments of the present invention provide systems 2000 and methods 1000 configured toward real-time, photo-realistic 3D reconstruction 130 of dynamic scenes 140, particularly (e.g. live sports events, concerts, performances, plays, theater performances, presentations, lectures, film productions, etc.) enabling interactive viewing from user-selected viewpoints (a viewpoint selected by the user/viewer 1). The core of various embodiments of the invention is a framework, referred to herein as “LiveSplats”, which leverages 3D primitives (e.g., Gaussian Spats) and introduces several innovations for parallel processing and efficient and high-quality reconstruction.

FIG. 1 provides an overview of one embodiment of a method 1000 of the present invention. As illustrated in FIG. 1, this embodiment takes a plurality of multi-view video streams 110 (meaning a multitude of views of a scene from different perspectives or points-of-view) of a dynamic, human-centered scene as input. In FIG. 1, the scene is a sporting event. An array or plurality of cameras 100 are arranged around the scene to capture the scene from multiple views, with different points-of-view or perspectives. The image streams 110 are comprised of a plurality of consecutive or adjacent frames (also referred to herein as “images”) at specific points in time t (t−2 113, t−1 114, t 115, t+1 116, t+2 117). As illustrated in FIG. 1, this collection 120 of multi-view video streams, with frames at specific times t, are processed by a 3D reconstruction system 130 and method 1000, which generate a novel (viewer-selected viewpoint) 3D video stream 140. This representation allows a viewer 1 to watch the event/scene from any viewer-selected viewpoint and outputs a novel video stream 140 viewable from these viewer-selected viewpoints at interactive frame rates. Also illustrated in FIG. 1, the novel video stream 140 comprises a reconstructed scene 150 comprised of a plurality of reconstructed frames at different times t (t−2 153, t−1 154, t 155, t+1 156).

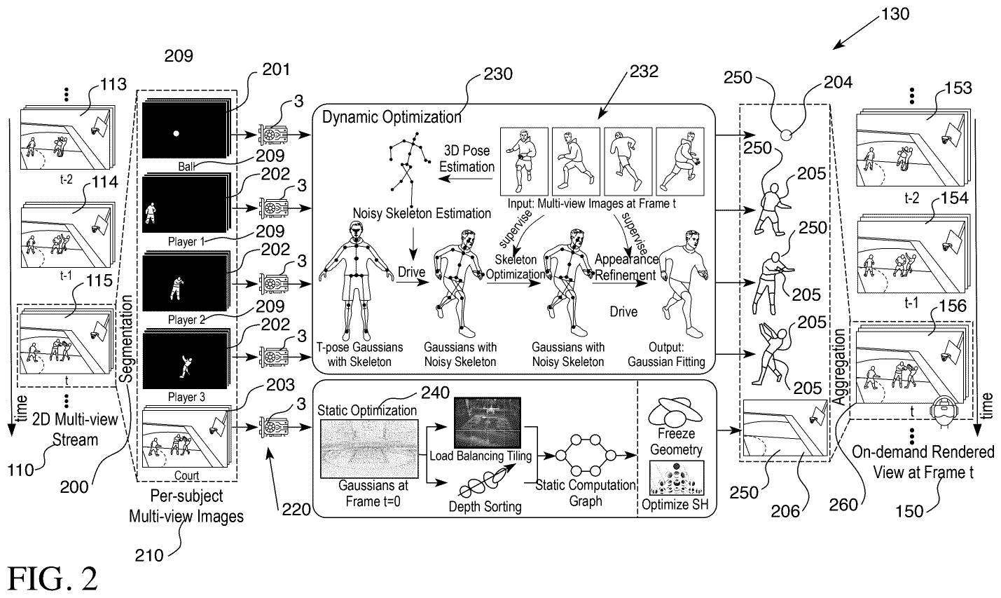

As shown in FIG. 2, one embodiment of the system architecture 2000 and method 1000 is designed for scalability and parallel processing 220 (parallel computing 220). The reconstruction system 2000 and method 1000 can be modeled using a two-level MapReduce approach, with parallel computing 220 applied across multiple processing units 3 (e.g., GPU-powered nodes). As is known in the art, MapReduce is a programming model that uses parallel processing to speed large-scale data processing. MapReduce enables scalability across many servers within a cluster. The name “MapReduce” refers to the two tasks that the model performs to help “chunk” a large data processing task into many smaller tasks that can run faster in parallel. First is the “map task,” which takes one set of data and converts it into another set of data formatted as key/value pairs. Second is the “reduce task,” which takes the outputs from a map task, aggregates all values with the same key and processes the data to produce a final set of key/value pairs. For purposes of the discussion herein, this is also referred to as “parallel processing 220” or “parallel computation 220”. Additionally, for the present invention, nodes 610 in a node-pool 610, 620 process individual frames (or sets of frames) independently, while processing units 3 within a node 610 handle the reconstruction of different scene components (e.g., individual actors, environment) in parallel. For each time frame “t” from the input multi-view streams 110 the following processes or methods are employed:
a) Segmentation 200: Multi-view images 113, 114, 115 are segmented 200 to obtain per-subject segmentation masks 202 (e.g., player) or per-object segmentation masks 201 (e.g., ball). For ease of discussion, any item, object, human, non-human, and/or environment that undergoes optimization of any type of dynamic optimalization 230 or static optimization 240 is referred to as an “element 209” unless more specifically noted. Additionally, any human that undergoes dynamic optimization 230 is referred to interchangeably as a “human” or as a “subject”). Objects can be referred to as “object(s)”, “non-subject(s)”, or as “non-human(s).” The same process applies to the environment 203 of a scene as illustrated in FIG. 2. The masked RGB images (or RGB-D images) for each subject, object, and/or environment are passed to respective processing units 3. Image masking is known in the art and is a technique used in photo editing to separate or isolate specific areas of an image from the rest, usually to enable more precise editing and manipulation. It is a digital equivalent of placing a “mask” over the parts of a picture you want to protect or hide while exposing the other areas for editing. FIG. 2 illustrates parallel computing 220 by the parallel processing units 3 receiving segmented frames or images 210.
b) Parallel Optimization by dynamic optimization 230 and static optimization 240 (via parallel computing 220): Each element 209 (person, ball, environment, etc.) is assigned to a dedicated processing unit 3 for 3D optimization parallel dynamic and static paths 230 and 240. The optimization logic or method depends on whether the element 209 is dynamic (e.g., a player or dynamic object (ball), processed via a dynamic optimization path 230) or static (e.g., the court, processed via static optimization path 240).
c) Aggregation 260: The optimized 3D primitives 250 for all elements 209 (subjects, objects, and the environment) are collected from each processing unit 3 and aggregated into a single, unified 3D model for that time frame t. Aggregation 260 refers to the ‘reduce’ step of the MapReduce formulation. This happens after each GPU has finished processing the dynamic or static element for a particular multi-view frame. As illustrated in FIG. 2, the optimized 3D primitives 250 are the optimized individual objects 204 and optimized individual humans 205 and the optimized environment 206.
d) Refinement 270: Refinement is a process of detecting the areas where there is most error (or a predetermined level of error) and adding 3D primitives to reduce the error.
e) Rendering 150: This aggregated model is then served for on-demand rendering from viewpoints selected by the clients.

For one embodiment of the present invention, at a time t, every processing unit 3 (GPU or computation node) receives all the images/frames (one per camera 100 that sees the element of interest) that belong to the element assigned to the processing node. Then the processor performs the steps of the reconstruction process 130.

A key design feature enabling scalability is that scene reconstruction at a given frame t operates independently of other frames. This allows for multiplexing the reconstruction of multiple adjacent or consecutive frames across available distributed computing resources. The total time “Tₜₒₜₐₗ” for a frame to be generated comprises image transfer time (“Tₜ”), reconstruction time (“Tᵣ”), the 3D Gaussian splatting model (“3DGS”) transfer time (“T_{b}”), and merging time (“Tₘ”). After an initial latency, the effective per-frame processing time with a number “N” nodes becomes Tᵣ/N, indicating linear scalability. The discussion herein refers interchangeably to a “current frame” or “t”, a previous frame or “t−1”, and a next frame or “t+1”.

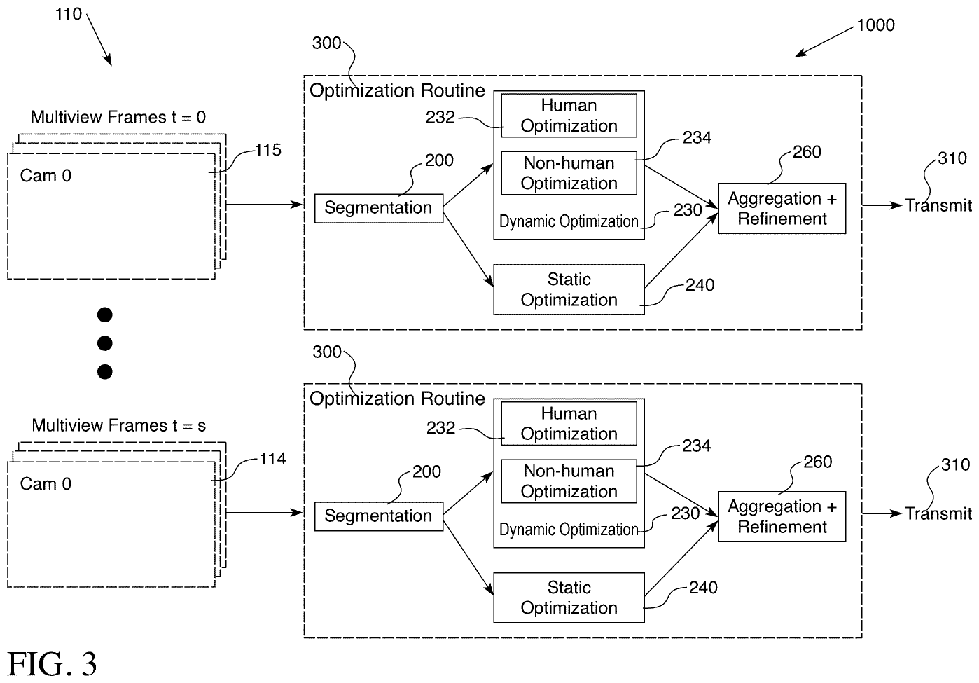

As illustrated in FIG. 3, frames are segmented 200 and then sorted into one of two optimization routines 300. One optimization routines 300 is a dynamic optimization 230 for dynamic elements. The second optimization routine 300 is a static optimization 240 for static elements. One novel aspect of these optimization routines 300 is that the frames across times t are run in parallel across parallel processing units. Prior work is limited by running one frame at a time (frame (t) and then one frame (t+1).) Various embodiments of the present invention are configured to run t frames in parallel. This is because, in part, each frame starts from the T-pose and does not depend on the results of the previous frame.

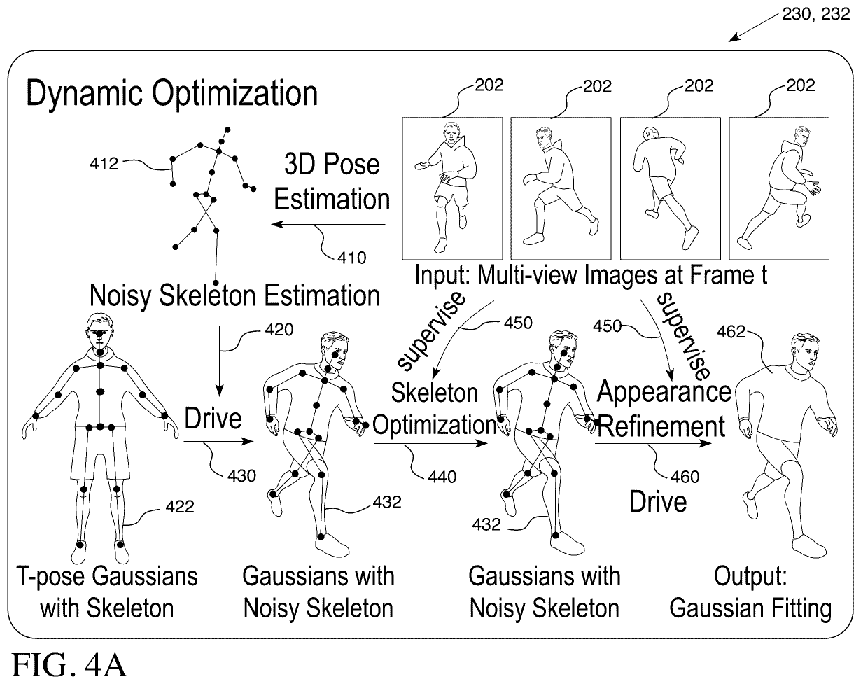

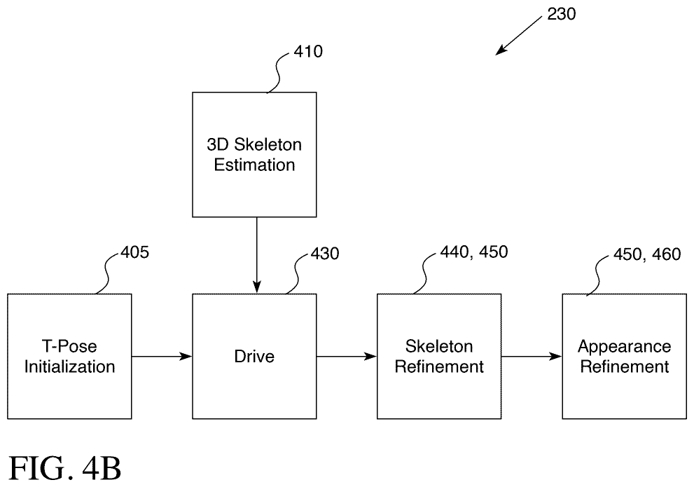

Dynamic Optimization Process (Humans+Objects) 230. As illustrated in FIGS. 3, 4A and 4B, one embodiment of an optimization process or method 300 of the invention is designed for dynamic elements that include humans and other moving objects (also referred to herein as “dynamic subjects 209”, “dynamic object 209”, or a “dynamic element 209”) in the scene or environment (which may have a foreground and a background) and aims (in some embodiments) to maintain fine-grained details during motion. FIG. 2 through 4 illustrate one embodiment of an optimization process 300 within the overall systems 2000 and methods 1000 of the present invention. The dynamic optimization process 230 employs a coarse-to-fine strategy including the following steps (a human example is provided below):
1) Initialization at time=1 (the following are performed for the first frame):
   a) A detailed splatting-based reconstruction of a human subject is generated in a reference T-pose 422 using multi-view images 202.
   b) A parametric human mesh model is fitted to the T-pose Gaussian centers to obtain a 3D skeleton and skinning weights.
   c) Each Gaussian primitive from the T-pose model is assigned to its nearest mesh vertex on the 3D human mesh model and inherits its skinning weights.
2) Per-Frame Processing for Dynamic Actor at time t:
   a) Pose Estimation 410: Multi-view 2D landmarks are extracted for each frame 202 and triangulated to compute the corresponding 3D posed skeleton 412.
   b) Skeleton-Driven Gaussian Transformation 420: The T-pose model 422 is transformed to the current frame's pose using the new 3D posed skeleton 412. This step produces Gaussians with a noisy skeleton estimation 432 (Input: Multi-view Images at Frame t 202, Skeleton Optimization 440). FIGS. 4A and 4B illustrate this transformation.
   c) Skeleton Optimization 440: A coarse optimization step is carried out where the transformed skeleton 432 is refined through an image based loss.
   d) Appearance Refinement 270 (shown in FIG. 4A at 460): Once the transformed skeleton 432 is optimized 440, all parameters of the primitives (position, scale, rotation, opacity, SH coefficients) are freely optimized 440 using the same photometric loss to enhance local structural details and adapt to illumination changes.

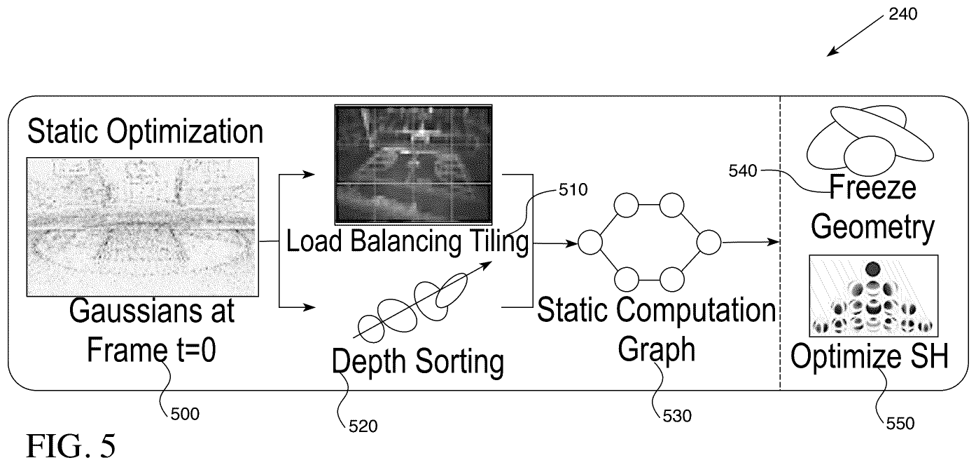

Static Optimization Process (Environment) 240. The static optimization process 240 (FIG. 2 and detailed in FIG. 5) is designed for the geometrically static parts of the scene, such as the court or stadium (frequently the environment). It assumes that only appearance (e.g., lighting, shadows) changes over time.
1) Initialization:
   a) A 3D Gaussian Splats model of the empty environment (e.g., court) is fitted using training views to capture its geometry accurately (Initial Gaussians at Frame 0) 500. Model density may be increased in regions of high viewer interest. Load balancing tiling 510 and depth sorting 520 can be performed.
2) The geometric parameters (position, scale, rotation) of these Gaussians are then frozen 540. Per-Frame Processing for Static Environment at time t:
   a) Spherical Harmonics (“SH”)-Only Optimization 550: For each subsequent frame, optimization focuses exclusively on the appearance parameters of the background Gaussians, thereby reducing computational overhead and flickering.
   b) Performance Enhancements: To maximize efficiency, several techniques are employed:
      i) Precomputation: The static nature of the primitives amounts to minimal changes in their state and are hence cached to avoid recomputation for each iteration.
      ii) Graphs 530: CPU interaction with accelerators is potentially bottlenecked by synchronization overheads between the devices. To alleviate this, GPU operations for rendering and SH optimization of static Gaussians are captured as a static computational graph, which allows for asynchronous replays of the optimization pipeline with minimal CPU intervention. Static computation graphing 530 can be employed as a way to represent the series of operations that need to be performed to render an image or a frame.
      iii) Load Balancing 510: Uneven Gaussian counts per pixel stall threads in splatting-based rasterization, which is alleviated by redistributing gaussians evenly across threads.

FIG. 4B illustrates a broad flowchart of dynamic optimization 230 in terms of five modules: (a) a 3D skeleton estimation module 410; (b) a T-pose initialization module 405; (c) a drive module 430 (which computes the difference between the T-pose from (b) and the 3D skeleton from (a) and performs computations for an initialization to the next module, which is the (d) skeleton refinement module 440 (which is informed/supervised 450 by the multi-view images 202); and (e) an appearance refinement module 460 (which also is informed and supervised 450 by the multi-view images 202), which receives information from the skeleton refinement module.

FIG. 4A provides details for the dynamic optimization 230 embodiment illustrated in the flowchart in FIG. 4B. Multi-view images or frames at a specific time t 202 are used as input to generate an optimized and refined model 462 after a Gaussian (or 3D primitives) fitting. The multi-view images 202 are processed by the 3D skeleton estimation module 410 to generate a noisy skeleton estimation 412, 420. A T-pose Gaussians (or 3D primitives) with skeleton 422 (from the T-pose initialization module) and the noisy skeleton estimation 420 are sent to the drive module 430 which outputs a Gaussian (or 3D primitives) model with a noisy skeleton 432. The Gaussian with noisy skeleton 432 undergoes a skeleton optimization 440 and appearance refinement 270 (via the appearance refinement drive 460) in the respective modules with the multi-view images 202 (several images at different views) used to guide, inform, supervise (collectively, “supervise 450”), the fitting algorithm for skeleton optimization. The result of these processes and modules is generation of a Gaussian (or 3D primitives) optimized and refined fitting model 462 is generated. For additional clarity, the output Gaussian fitting 462 is the optimized 3D primitives (that are Gaussians in this one embodiment). That is, the output of the dynamic optimization process 230 is the optimized 3D Gaussians or the optimized 3D primitives.

FIG. 5 illustrates one embodiment of a static optimization process, method or module 240. The embodiment of static optimization 240 illustrated in FIG. 5 begins with Gaussians at frame t=0. FIG. 5 then illustrates a few performance enhancements that can be employed to maximize efficiency. In the precompute module (explained more fully below), the static nature of the primitives amounts to minimal changes in their state and are hence cached to avoid recomputation for each iteration. Additionally, CPU interaction with accelerators is potentially bottlenecked by synchronization overheads between the devices. To alleviate this, GPU operations for rendering and SH optimization 550 of static Gaussians are captured as a static computational graph 530, which allows for asynchronous replays of the optimization pipeline with minimal CPU intervention. The load balancing modules 510 addresses uneven Gaussian counts per pixel, which stall threads in splatting-based rasterization. This is alleviated by redistributing gaussians evenly across threads.

As further explanation of the embodiment illustrated in FIG. 5 and described previously, the “precompute module” (and the phrase used previously, “precomputation”) refers to the left side of the figure, meaning Gaussians at frame t=0 500, load balancing tiling 510, depth sorting 520, and the use of static computation graph 530. These processes occur at the frame 0. The portion of the system 2000 and method 1000 illustrated in FIG. 5 takes all the frames from the cameras, reconstructs the initial Gaussians and performs load balancing tiling 510, depth sorting 520, and the use of static computation graph 530. The results of these processes are stored in memory. In the subsequent frames, t>0, the results obtained in t=0 are used to perform SH-optimization 550 faster than existing comparable methods and systems.

FIG. 6 illustrates one embodiment of a system 2000 configured to run the methods 1000 disclosed herein. The hardware shown is not exclusive of other hardware and components that are needed and obvious to one skilled in the art to effectuate the states goals of the invention. As illustrated in FIG. 6, this embodiment a plurality of cameras 100 capture a plurality of multi-view video streams 110 (meaning a multitude of views of a scene from different perspectives or points-of-view) of a dynamic, human-centered scene as input. This array or plurality of cameras 100 are arranged around the scene to capture the scene from multiple views, different points-of-view or perspectives. The image streams 110 are comprised of a plurality of consecutive or adjacent frames (also referred to herein as “images”) that are temporarily stored in at least on buffer 4. As illustrated in FIG. 6, this collection 120 of multi-view video streams, with frames at specific times t, are processed by plurality of parallel processing notes 610, 620, etc. Each processing node 610 includes at least one processing unit 3. As previously elaborated upon, each frame is processed in parallel by a plurality of processors 4 (GPUs in FIG. 6). The processed frames are aggregated in an aggregation module 260 and send to a streaming server 630 configured with rendering hardware 631 that renders the aggregated frames and feeds them to a streaming buffer 626 to be handled prior to being sent to the viewing device 2 This system 2000 creates a novel 3D representation stream 140 that can be manipulated by a viewer 1 such that the viewer 1 can choose to watch the event/scene from any viewer-selected viewpoint.

The following discussion is of one embodiment of the present invention, identified as a “first embodiment” with subsequent embodiments layering on additional details as other embodiments. One embodiment of the present invention (a “first embodiment”) is a computer system 2000 configured for real-time three-dimensional reconstruction of a dynamic scene from multi-view video streams 110. The system 2000 of this embodiment comprises at least one processing unit 3 and memory 4 configured to receive 2D multi-view video streams 110 capturing a human-centered dynamic scene such as, but not limited to, sports events or concerts. The system 2000 has a distributed collection of processing nodes 610 (e.g., GPUs, TPUs), each comprising one or more processing units 3 configured for parallel computation 220 of several consecutive multi-view frames 113, 114, 115, 116, 117. Additionally, the system 2000 is configured to run a reconstruction process 130 for generating a 3D representation 140 of the dynamic scene from the multi-view video streams 110 and the reconstruction method 130 comprising the following steps:
1. segmenting 240 the multi-view video streams 110 into two types of regions or categories: dynamic elements (e.g., people, moving objects) and non-dynamic elements (e.g., static background);
2. performing a static optimization process 240 on the static elements (non-dynamic) identified in a scene by starting with a given set of an initial 3D primitives (e.g., Gaussian splats) and updating the 3D primitives for static elements to reconstruct the static elements in the scene;
3. performing a dynamic optimization process 230 on the dynamic elements identified in a scene by starting with a given set of an initial 3D primitives (e.g., Gaussian splats) updated the 3D primitives for dynamic elements to reconstruct the dynamic elements in the scene, including by employing a specialized fitting mechanism for Gaussian splats corresponding to human elements; and
4. aggregating 260 and refining 270 the optimized 3D primitives to reconstruct dynamic and non-dynamic elements into a unified 3D model/scene representation and, optionally, identifying regions of the reconstructed scene with significant (predetermined) reconstruction error and applying a densification strategy to insert additional 3D primitives (e.g., Gaussian splats) in such regions to improve fidelity.
   Steps 1-3 are run using parallel computation 220.

A second embodiment of the present invention, builds upon the previously-described first embodiment such that the static optimization 240 is configured to do the following (for identified geometrically static portions of the scene in the current time frame): (a) maintain a set of 3D primitives with fixed geometric parameters (position, scale, rotation), for the flat surfaces (e.g., floor, wall) 2D primitives can be used; and (b) optimize only appearance parameters, primarily SH coefficients 550, of said static Gaussian primitives to account for view-dependent appearance changes by minimizing said photometric loss.

A third embodiment of the present invention, builds upon the previously-described first embodiment and is configured such that the performing the dynamic optimization 230 includes the following steps for each dynamic element classified as a subject identified in a current time frame t 202, the dynamic optimization 230 initializes and refines 3D Gaussian primitives corresponding to the subject by:
1. Transforming a set of 3D Gaussian primitives associated with the dynamic subject from a reference pose, as obtained by the system of the previously-described first embodiment, to the current pose based on an estimated 3D skeleton 410;
2. Performing a skeleton optimization process 440 to refine the 3D skeleton by minimizing a photometric loss between renderings of the transformed Gaussian primitives 432 and ground truth images 202 captured from the multi-view video streams 110;
3. Performing an appearance refinement process 270, 460 to optimize parameters of the transformed 3D Gaussian primitives, including but not limited to position, scale, rotation, opacity, and spherical harmonics (“SH”) coefficients, by minimizing the same photometric loss. This process can include any of the following optional steps:
   a. Over-densification (placing more Gaussians) near the joints to facilitate stretching or squeezing at the regions where they appear most and to model non-rigid deformations.
   b. Regularization on the scale of Gaussians to avoid thin, long-slivers of Gaussians.
   c. Randomization of backgrounds while training to eliminate Gaussians far from the skin. More specifically, in one embodiment, during a training process, the background of the images are randomly changed using various colors. This makes the Gaussians of the subject (or element of interest) more solid and the ones (elements not of interest in that image) that are far from the subject are eliminated.
   d. Regularization with the distance of the Gaussian center from the mesh surface to avoid large offsets from the skin.

Additionally, for this third embodiment, the dynamic optimization module 230 performs the following steps for each dynamic elements classified not classified as human subjects (or classified as a non-human or an object):
1. Initializing an approximate surface for an object at the first frame in which the object is seen, by projecting the view frustums as six-sided truncated pyramid meshes, computing the mesh intersection, and performing space carving. This applies to only non-human dynamic objects of any shape. The goal is to identify a 3D object silhouette by projecting the view frustums from all camera directions, followed by their intersection, to compute a 3D volume that encompasses the object to generate an obtained surface.
2. Initializing the 3D Gaussian primitives on the obtained surface and fine-tunes on the appearance. This surface is approximated after the intersections from all view frustums are calculated. This process is called ‘space carving’ in computer graphics. The predicted surface is treated as a ‘good enough’ approximation for initializing the geometry of the 3D gaussians
3. For successive frames, optimizing the primitives based on 2D optical flows lifted to 3D to estimate motion and regularizes on temporal consistency strategy.

A fourth embodiment of the present invention builds upon the first embodiment described above, wherein the aggregation module 260 configured to combine the optimized 3D Gaussian primitives from the dynamic elements and the 2D gaussian primitives for the static portions into a unified 3D scene/model for the current time frame 150. In this step, a few approaches are possible (in various embodiments some or all of the following can be used):
1. Over-densification (placing more small Gaussians) near the points of focus, e.g. the basket, pole, stadium surface for a basketball game scene.
2. Regularization on the rendered depth and normals with the ground truth depth and normals, respectively.
3. Regularization on the scale of Gaussians to avoid thin, long-slivers of Gaussians.
4. Employing an appearance network trained on the color parameters to avoid modelling transient effects during the fly-through capture

A fifth embodiment (illustrated in FIG. 5) based upon the primary system described above is configured wherein the static 240 and dynamic optimization modules 230 further comprise one or more of:
1. a precomputation unit (or a precomputation module as previously discussed) configured to precompute and cache depth-sorted lists of the static Gaussian primitives for rasterizer tiles;
2. a Compute Unified Device Architecture (“CUDA”) graph execution unit configured to record and replay processing unit 3 (e.g., GPU) operations for rendering and SH optimization 550 of static Gaussian primitives as a CUDA graph 530; and
3. a load balancing unit 510 configured to partition the static Gaussian primitives 500 within each rasterizer tile into a plurality of sub-tiles, each subtile processed by a separate processing unit 3 thread block.

The systems and methods of the present disclosure readily achieve the ends and advantages mentioned as well as those inherent therein. While certain embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments.

What is claimed:

1. A computer system for real-time three-dimensional reconstruction of a dynamic scene from a plurality of multi-view video streams, the system comprising:
a video acquisition system configured to run on at least one processor with at least one memory configured to receive and store a plurality of multi-view video streams of a human-centered dynamic scene, wherein each video stream is comprised of a plurality of consecutive frames and each frame is at a time t;
a plurality of processing nodes, each node comprising at least one processing unit configured for parallel computation of the frames, wherein the memory, processing nodes, and processing units are configured to generate a three-dimensional representation of the dynamic scene by performing the following steps:
processing the multi-view video streams into dynamic elements and static elements;
optimizing by updating an initial set of three-dimensional primitives for each static element to compute an updated three-dimensional representation of the static element;
optimizing by updating an initial set of three-dimensional primitives for each dynamic element to compute an updated three-dimensional representation of each of the dynamic elements, wherein a specialized fitting mechanism for three-dimensional primitives is employed if the dynamic elements is a human;
reconstructing the dynamic elements and the static elements utilizing a composition and refinement module configured to run the following steps on the parallel processing nodes with parallel computation:
aggregating and integrating the reconstructed dynamic and static elements into a unified three-dimensional model,
identifying regions of the scene representation having a predetermined reconstruction error, and
applying a densification process to insert additional three-dimensional primitives in the identified regions with the predetermined reconstruction error to improve a degree of fidelity to the human-centered dynamic scene.

2. The system of claim 1, wherein optimizing the dynamic elements to reconstruct the dynamic elements also comprises identifying at least one geometrically static portion of the scene representation in a current time frame and, for the geometrically static portion, further comprising:
maintaining a set of three-dimensional primitives with fixed geometric parameters, and
optimizing at least one appearance parameter of the set of three-dimensional primitives with fixed geometric parameters to account for a view-dependent appearance change by minimizing a photometric loss.

3. The system of claim 2, wherein the at least one appearance parameter is a plurality of spherical harmonics coefficients.

4. The system of claim 1, wherein optimizing the dynamic elements to reconstruct the dynamic elements also comprises identifying geometrically static portions of the scene representation in a current time frame and, for the geometrically static portions, also comprising:
maintaining a set of 2D primitives with fixed geometric parameters for flat surfaces, and
optimizing at least one appearance parameter of said 2D primitives with fixed geometric parameters to account for view-dependent appearance changes by minimizing a photometric loss.

5. The system of claim 1, where the dynamic optimization for each dynamic element identified in a current time frame is configured to:
identify and classify dynamic elements as dynamic subjects or dynamic non-subjects;
initialize and refine the corresponding three-dimensional primitives, for the subjects, by employing a process comprising:
identifying a reference pose for each dynamic subject,
transforming a set of three-dimensional primitives associated with the dynamic subject from the reference pose to a current pose based on an estimated three-dimensional skeleton,
performing a skeleton optimization process to refine the estimated three-dimensional skeleton by minimizing a photometric loss between a plurality of renderings of the transformed three-dimensional primitives and a ground truth images captured from the multi-view video streams, and
performing an appearance refinement process to optimize at least one parameter of the transformed three-dimensional primitives selected from the group consisting of position, scale, rotation, opacity, and spherical harmonics coefficients; and
initialize and refine the corresponding three-dimensional primitives for the dynamic non-subjects, by employing a process comprising:
initializing an approximate surface for an object at a first frame in which the object is identified, by projecting a plurality of view frustums as six-sided truncated pyramid meshes, computing the mesh intersection and performing space carving to obtain an obtained surface,
initializing the three-dimensional primitives on the obtained surface and finetuning an appearance of the surface of the object, and
for successive frames, optimizing the three-dimensional primitives based on a plurality of 2D optical flows lifted to three-dimensional to estimate a motion of the object and to regularize on temporal consistency strategy.

6. The system according to claim 5, wherein, for the step of performing an appearance refinement process to optimize at least one parameter of the transformed three-dimensional primitives, the at least one parameter is selected from the group consisting of position, scale, rotation, opacity, and spherical harmonics coefficients; and at least one of the following processes is performed:
over-densification near the joints to facilitate stretching or squeezing at the regions where they appear most and to model non-rigid deformations;
regularization on the scale of the three-dimensional primitives to avoid thin, long-slivers of three-dimensional primitives;
random backgrounds while training to eliminate three-dimensional primitives far from the skin; and
regularization with the distance of the three-dimensional primitive center from the mesh surface to avoid large offsets from the skin.

7. The system of claim 1, wherein the aggregation module configured to combine the optimized three-dimensional primitives from the dynamic subjects and the 2D primitives for the static elements into a unified three-dimensional model for the current time frame also comprising at least one of the following processes:
over-densification near at least one predetermined point of focus;
regularization on the rendered depth and normals with the ground truth depth and normals, respectively;
regularization on the scale of the three-dimensional primitives to avoid thin, long-slivers of the three-dimensional primitives; and/or
an appearance network trained on the color parameters to avoid modelling transient effects during the fly-through capture.

8. The system of claim 1 wherein the static and dynamic optimization module further comprises at least one of the following:
a precomputation unit configured to precompute and cache depth-sorted lists of the static Gaussian primitives for rasterizer tiles;
a CUDA graph execution unit configured to record and replay processing unit (e.g., GPU) operations for rendering and SH optimization of static Gaussian primitives as a CUDA graph;
and/or a load balancing unit configured to partition the static Gaussian primitives within each rasterizer tile into a plurality of sub-tiles, each subtile processed by a separate processing unit thread block.

9. A computer-implemented method using at least one processing unit with memory for creating a three-dimensional reconstruction of a dynamic scene from a plurality of 2D video streams, each 2D stream comprised of plurality of consecutive frames and each frame at a time “t”, comprising the following steps for each time “t”:
identifying at least one element in an environment a frame at a time;
segmenting the frame to obtain at least one per-element segmentation mask and categorizing the element as dynamic or static;
optimizing, using one of a plurality of parallel processor units, by employing an optimization method for dynamic elements or an optimization method for static elements to create an optimized and refined model for the dynamic elements and the static elements;
aggregating, from each parallel processing unit, the optimized and refined models for all elements into a unified three-dimensional model for the time t; and
refining by detecting an area where a predetermined error level is exceeded and adding at least one three-dimensional primitive to reduce the error; and
rendering a unified three-dimensional model for the time t.

10. The method of claim 9, wherein the optimizing method for a dynamic element that is a human comprises:
gathering a plurality of multi-view frames showing the human at time t;
generating an estimated three-dimensional pose model of the human;
generating a detailed splatting-based reconstruction of the human using three-dimensional primitives on a reference T-pose model;
fitting a parametric human mesh model having mesh vertices to the T-pose model to obtain a three-dimensional skeleton and at least one skinning weights;
assigning each of the three-dimensional primitives from the T-pose model to a nearest mesh vertex on the three-dimensional human mesh model and each of the three-dimensional primitive inherits a skinning weight;
extracting, for each frame at time t, at least one 2D landmark and triangulating to compute a corresponding three-dimensional posed skeleton; and
refining the three-dimensional posed skeleton by optimizing at least one parameter of the primitives to create the optimized and refined model.

11. The method of claim 10, wherein the at least one parameter is selected from the group consisting of position, scale, rotation, opacity, and spherical harmonic coefficients.

12. The method of claim 9, wherein the optimizing method for the static element that is an environment having a foreground and a background, comprises:
fitting a three-dimensional primitives model of an empty version of the environment using a plurality of training views to capture a geometry of the environment, wherein the three-dimensional primitives have geometric parameters;
optionally, increasing a density of the model of the environment in a region of interest; and
freezing the geometric parameters of the three-dimensional primitives.

13. The method of claim 12, further comprising performing the following per-frame processing steps for the environment at time t:
optimizing, for spherical harmonics only for a subsequent frame at time t+1, by focusing exclusively on one or more appearance parameters of three-dimensional primitives in the background.

14. The method of claim 13, further comprising any of the following performance enhancements:
caching any changes to the three-dimensional primitives in the background to avoid recomputation for each iteration;
capturing any operations of the processor for rendering and spherical harmonics optimization of static three-dimensional primitives as a static computational graph; and
redistributing Gaussians to balance an uneven Gaussian counts per pixel count.

15. A non-transitory computer-readable storage medium storing one or more programs for creating a three-dimensional reconstruction of a dynamic scene from a plurality of 2D video streams, each 2D stream comprised of plurality of consecutive frames and each frame at a time “t”, the one or more programs comprising instructions, which when executed by at least one processor of an electronic system, cause the electronic system to perform the following steps for each time “t”:
identifying at least one element in an environment a frame at a time;
segmenting, using a processing unit, the frame to obtain at least one per-element segmentation mask and categorizing the element as dynamic or static;
optimizing, using one of a plurality of parallel processor units, by employing an optimization method for dynamic elements or an optimization method for static elements to create an optimized and refined model for the dynamic elements and the static elements;
aggregating, from each parallel processing unit, the optimized and refined models for all elements into a unified three-dimensional model for the time t; and
refining by detecting an area where a predetermined error level is exceeded and adding at least one three-dimensional primitive to reduce the error; and
rendering a unified three-dimensional model for the time t.

16. The non-transitory computer-readable storage medium of claim 15, wherein the optimizing method for a dynamic element that is a human comprises:
gathering a plurality of multi-view frames showing the human at time t;
generating an estimated three-dimensional pose model of the human;
generating a detailed splatting-based reconstruction of the human using three-dimensional primitives and a reference T-pose model;
fitting a parametric human mesh model having mesh vertices to the T-pose model to obtain a three-dimensional posed skeleton and at least one skinning weight;
assigning each of the three-dimensional primitives from the T-pose model a nearest mesh vertex on the three-dimensional human mesh model and each of the three-dimensional primitive inherits its skinning weights;
extracting, for each frame at time t, at least one 2D landmarks and triangulating to compute the corresponding three-dimensional posed skeleton; and
refining the three-dimensional posed skeleton by optimizing at least one of the parameters of the primitives to create the optimized and refined model.

17. The non-transitory computer-readable storage medium of claim 16, wherein the at least one parameter is selected from the group consisting of position, scale, rotation, opacity, and spherical harmonic coefficients.

18. The non-transitory computer-readable storage medium of claim 15, wherein the optimizing method for the static element that is an environment having a foreground and a background, comprises:
fitting a three-dimensional primitives model of an empty version of the environment using a plurality of training views to capture a geometry of the environment, wherein the three-dimensional primitives have geometric parameters;
optionally, increasing a density of the model of the environment in a region of interest; and
freezing the geometric parameters of the three-dimensional primitives.

19. The non-transitory computer-readable storage medium of claim 18, further comprising performing the following per-frame processing steps for the environment at time t:
optimizing, for spherical harmonics only for a subsequent frame at time t+1, by focusing exclusively on one or more appearance parameters of three-dimensional primitives in the background.

20. The non-transitory computer-readable storage medium of claim 19, further comprising any of the following performance enhancements:
caching any changes to the three-dimensional primitives in the background to avoid recomputation for each iteration;
capturing any operations of the processing unit for rendering and spherical harmonics optimization of static three-dimensional primitives as a static computational graph; and
redistributing Gaussians to balance an uneven Gaussian counts per pixel count.

21. A computer system for real-time three-dimensional reconstruction of a dynamic scene from a plurality of multi-view video streams, the system comprising:
a video acquisition system configured to run on at least one processor with at least one memory configured to receive and store a plurality of multi-view video streams of a human-centered dynamic scene, wherein each video stream is comprised of a plurality of consecutive frames and each frame is at a time t;
a plurality of processing nodes, each node comprising at least one processing unit configured for parallel computation of the frames, wherein the memory, processing nodes, and processing units are configured to generate a three-dimensional representation of the dynamic scene by performing the following steps comprising the following steps for each time “t”:
identifying at least one element in an environment a frame at a time;
segmenting, using a processing unit, the frame to obtain at least one per-element segmentation mask and categorizing the element as dynamic or static;
optimizing, using one of a plurality of parallel processor units, by employing an optimization method for dynamic elements or an optimization method for static elements to create an optimized and refined model for the dynamic element and the static elements;
aggregating, from each parallel processing unit, the optimized and refined models for all elements into a unified three-dimensional model for the time t; and
refining by detecting an area where a predetermined error level is exceeded and adding at least one three-dimensional primitive to reduce the error; and
rendering a unified three-dimensional model for the time t.
